(19) United States
(12) Patent Application Publication
(10) Pub. No.: US 2020/0058958 A1
(43) Pub. Date: Feb. 20, 2020

(54) RECHARGEABLE SODIUM CELLS FOR HIGH ENERGY DENSITY BATTERY USE

(71) Applicant: BROADBIT BATTERIES OY, Espoo (FI)

(72) Inventors: Andras KOVACS, Espoo (FI); Débora RUIZ-MARTÍNEZ, Alicante (ES); Roberto GÓMEZ-TORREGROSA, Alicante (ES); Tapani ALASAARELA, Helsinki (FI); David P. BROWN, Helsinki (FI)

(73) Assignee: BroadBit Batteries Oy, Espoo (FI)

(21) Appl. No.: 16/082,101

(22) PCT Filed: Mar. 3, 2017
(86) PCT No.: PCT/FI2017/050139

§ 371 Date: Sep. 4, 2018

(30) Foreign Application Priority Data
Mar. 4, 2016 (FI) 20165184

(51) Int. Cl. H01M 10/0567; H01M 4/38; H01M 10/0568; H01M 10/0569; H01M 4/66; H01M 4/58; H01M 10/054; H01M 10/42

(52) U.S. Cl. CPC H01M 10/0567; H01M 4/381; H01M 10/0568; H01M 10/4235; H01M 4/661; H01M 4/5815; H01M 10/054; H01M 10/0569

(57) ABSTRACT

An electrochemical cell for an energy-dense rechargeable battery is provided. The cell includes a solid metallic sodium anode, which is deposited over a suitable current collector during the cell charging process. Several variations of compatible electrolytes are disclosed, along with novel cathode materials for building the complete high-energy battery cell.

### FIELD OF THE INVENTION

Generally the invention relates to rechargeable electrochemical cells, batteries and supercapacitors. In particular, the present invention concerns the aforesaid devices utilizing metallic sodium anodes, a novel class of organic electrolyte composition compatible with the use of metallic sodium anodes, novel cathodes supporting high energy density, and solutions for electrolytes compatible with the disclosed electrodes.

### BACKGROUND

Intensive research is being conducted in the field of battery technology to find a more cost-effective and better performing battery technology than the presently dominant Li-ion technology. A recently introduced Sodium-based battery technology [1] sets a new high standard in terms of battery energy density, power density, and cost-efficiency. While progress beyond the battery qualities achieved in [1] is very challenging, the aim of the present invention is twofold. On the one hand, it aims to disclose a solution to the long-standing challenge of working with metallic Sodium based anodes in organic electrolyte containing cells, which are assembled in the discharged state. Resolving this challenge allows retaining the current organic electrolyte based cell architecture and the utilization of existing cell production machinery and processes, thus resulting in a new battery technology which could be manufactured without a need for significant modification to the production machinery or processes. Additionally, the present invention aims to progress even further in terms of energy density. Achieving even higher energy density at reasonable production costs would be advantageous for many battery applications requiring high energy density. Several new battery applications, such as commercial electric airplanes, may be enabled by such energy-dense battery technology.

The reversible use of metallic sodium anodes in certain ether-based organic electrolytes has been described in [2], however that cell architecture only allows sodium-over-sodium cycling and does not support sodium deposition from a discharged state. The sodium deposition from discharged state and the reversible use of metallic sodium anodes has been described in [1] for certain nitrogen-containing concentrated electrolytes, which requires a highly concentrated electrolyte salt and has a limited electrolyte voltage window. Some recent publications, such as [4] and [5], describe cathode structures based on the high-capacity Li₂S material, which is slowly activated during the first charging cycle. Construction of cathodes from Na₂S material has not been previously reported. The slow charging of Na₂S based electrodes has been attempted, with the in-situ deposited polypyrrole conductive additive prepared according to the procedure described in [5], but the electrodes have apparently failed to activate. In the lithium battery context, non-breathing lithium-oxygen battery formulations have recently been described [3]. The present invention is advantageous in several aspects with respect to the battery cell described in [3], such as the use of sodium instead of lithium, simpler cathode material synthesis, and higher capacity and operating voltage capability. Reversible sodium-over-sodium cycling of metallic sodium anodes in certain ether-based organic electrolytes has been described in [2], and this publication identified NaPF₆ salt in diglyme as a particularly effective electrolyte composition for this purpose. The observed anode qualities have been attributed in [2] to the Solid

Electrolyte Interface (SEI) layer being comprised of mainly Na₂O and NaF, originating from the ether solvent and NaPF₆ salt decomposition respectively.

Additionally, in order to make the best utilization of the sodium anode capacity, new high-capacity cathode materials are needed which are at the same time able to facilitate discharged-state cell assembly. The metallic sodium anode and novel cathode material based battery cell inventions disclosed herein are therefore of high industrial importance and open up a new approach to the building of cost-effective yet high-performance batteries.

It would be advantageous to industry and commerce to provide a means to achieve higher cell-level energy density and to improve cost-efficiency through the use of Sodium-based battery cells.

### SUMMARY OF THE INVENTION

In the current invention, the limitations relating to the use of certain nitrogen-containing concentrated electrolytes, requiring a highly concentrated electrolyte salt and having a limited electrolyte voltage window are overcome, and the advantages of the use of metallic sodium on the anode side are expanded to allow the use of its very high (1100 mAh/g) anodic capacity, which may be cycled with a very high longevity. In order to make the best utilization of this anode capacity, new high-capacity cathode materials are disclosed, which are, at the same time, able to facilitate discharged-state cell assembly. The metallic sodium anode and novel cathode material based battery cell inventions disclosed herein are therefore of high industrial importance and open up a new approach to the building of cost-effective yet high-performance batteries.

An objective of the present invention is to disclose high-performance electrochemical cells for secondary (i.e. rechargeable) high-energy and high-power batteries, based on anodes comprising metallic sodium. In a preferred embodiment, the cell is provided with a metallic anode, preferably a solid metallic anode, which is electrodeposited during the cell's first charging cycle, a cathode selected from the electrode structures disclosed in this invention, and an electrolyte selected from the electrolytes disclosed in this invention.

One aspect of the invention relates to disclosing organic solvent based electrolytes that support the stable deposition and cycling of a metallic sodium anode, and are capable of supporting a high voltage window of the battery cell. Another aspect relates to disclosing a current collector material supporting electrochemical deposition of sodium and preferably an essentially smooth, dendrite-free and/or preferably well-adhering electrochemical deposition of sodium. The electrochemical deposition of sodium is a practical requirement for an effective implementation of the present invention.

Smooth is here defined to be having a surface roughness of below 100 micron and more preferably below 10 micron and most preferably below 1 micron. Dentrite-free is here defined as having preferably less than 90% and more preferably less than 50% and more preferably less than 20% and more preferably less than 10% and more preferably less than 5% and most preferably less than 2% of the total mass of the sodium deposit as dendrites or dendritic structures. Well adhering is here defined to be maintained in contact with the substrate either by direct adhesion or by the application of a force pressing the deposit against its substrate. Stable cycling is here defined to be consumption of preferably less than 50% and more preferably less than 25% and more preferably less than 10% and most preferably less than 5% consumption of the electrolyte in the course of at least 100 cycles, and more preferably at least 1000 cycles, and most preferably at least 10000 cycles.

This electrochemical sodium deposition takes place during the first charging cycle for cells assembled in the discharged state, thereby alleviating the need for working with or handling metallic sodium during the cell production process. The identification of a suitable current collector substrate for such sodium deposition and a suitable electrolyte for deposition over this substrate are interrelated and only a subset of those electrolytes supporting sodium over sodium deposition also support sodium deposition over current collector substrates. The use of matching electrolyte—current collector substrate couples, based on organic solvent precursors, is therefore a main disclosure of the present invention.

In a further aspect, the invention relates to disclosing novel high-capacity cathode materials, which are compatible with these newly discovered metallic anode-electrolyte structures.

In a still further aspect, the invention relates to the use of electrochemical batteries, preferably electrochemical secondary batteries, comprising a number of cells according to any of the embodiments thus provided. The term “cell” refers in this disclosure to an electrochemical cell as a smallest, packed form of a battery. The term “battery” refers to a group of one or more of the abovesaid cells (a stack of cells, for example), unless otherwise indicated.

The utility of the present invention arises from a variety of reasons depending on each particular embodiment thereof, such as increased energy density per mass unit, increased cell voltage, or increased longevity or durability. Cost-effective implementation of the battery disclosed herewith will positively affect many battery-powered products.

Sodium-based metal anodes provide some of the highest theoretical gravimetric capacities of any anode material: the gravimetric capacity of sodium is over 1100 mAh/g, along with a potential of −2.7 V vs. Standard Hydrogen Electrode (SHE) for the Na+/Na couple. For comparison, current graphite anodes for lithium-ion batteries have a gravimetric capacity of around 400 mAh/g. Furthermore, metallic anodes do not require solid-state diffusion of ions to transfer material from the charged to the discharged state, but merely the successful deposition/dissolution of the ions on/from the surface of the metal.

Different embodiments of the present invention will become apparent by consideration of the detailed description and accompanying drawings.

### BRIEF DESCRIPTION OF THE DRAWINGS

FIG. 1 shows the electrochemical behavior for sodium deposition over sodium in the diglyme solvent based electrolyte, containing 1.2 molar Na-Triflate salt and 0.02 mole fraction of SO₂ additive. The experiments were performed in a three-electrode cell at a sweep rate of 20 mV/s using sodium metal as a reference and counter electrode. The geometric exposed area of the working electrode is 1 cm².

FIG. 2 shows the electrochemical behavior of sodium deposition over sodium in the DOL:DME solvent based electrolyte, containing 2 molar Na-Triflate salt and 0.01 mole fraction of SO₂ additive. The DOL:DME solvent is composed of a 1:1 mixture between 1,3-Dioxolane and 1,2-Dimethoxyethane. The experiments were performed in a three-electrode cell at a sweep rate of 20 mV/s using sodium metal as a reference and counter electrode. The geometric exposed area of the working electrode is 1 cm².

FIG. 3 shows the electrochemical behavior of sodium deposition over copper in the diglyme solvent based electrolyte, containing 0.64 molar NaPF6 salt, with and without the use of SO₂ additive. The experiments were performed in a three-electrode cell at a sweep rate of 20 mV/s using sodium metal as a reference and counter electrode. The geometric exposed area of the working electrode is 1 cm².

FIG. 4 shows the electrochemical behavior of sodium deposition over copper in the DOL:DME solvent based electrolyte, containing 2 molar Na-Triflate salt and 0.01 mole fraction of SO₂ additive. The experiments were performed in a three-electrode cell at a sweep rate of 20 mV/s using sodium metal as a reference and counter electrode. The geometric exposed area of the working electrode is 1 cm².

FIG. 5 shows the comparative visual aspect of sodium deposition over copper in DOL:DME solvent based electrolytes, containing 2 molar Na-Triflate salt and varying mole fractions of SO₂ additive. The DOL:DME solvent is composed of a 1:1 mixture between 1,3-Dioxolane and 1,2-Dimethoxyethane. From left to right, the employed mole fractions of SO₂ additive are 0.1, 0.05, 0.01, and 0.

FIG. 6 shows the cell voltage evolution and initial cell capacity evolution during charge/discharge cycling of polypyrrol covered Na₂S active material in the DME solvent based electrolyte. The capacity is indicated with respect to the Na₂S mass.

FIG. 7 shows the molecular structure of the Triazine-Quinone co-polymer cathode material, which can be described by the [C₈H₂N₂O₂Na₂]ₙ formula.

### DETAILED DESCRIPTION OF THE EMBODIMENTS

Detailed embodiments of the present invention are disclosed herein with reference to accompanying drawings.

The following paragraphs firstly describe a novel type of organic electrolyte composition and corresponding current collector substrate-electrolyte couples for the deposition and cycling of the metallic sodium anode. Subsequently, matching cathode compositions are disclosed.

The disclosed electrochemical cells are implemented so as to allow reversible redox interaction of metal ions with the cathode electrode during charge-discharge cycles. The term “reversible redox interaction” refers to the ability of an ion to both get inserted into or onto and to depart from the electrode material, preferably while not causing significant degradation of the latter and therefore not exerting significant negative effect on the performance characteristics of said electrode over repeated cycling. A reversible redox interaction preferably allows greater than 1 and more preferably greater than 10 and more preferably greater than 100 and more preferably greater than 1000 and most preferably greater than 10000 charge-discharge cycles while degrading cell performance preferably less than 80% and more preferably less than 40% and more preferably less than 20% and more preferably less than 10% and most preferably less than 5%. Other ranges are possible according to the invention.

It has been surprisingly discovered that reversible sodium-over-sodium cycling of metallic sodium anodes can be achieved in a wide class of non-aqueous solvents, which are characterized by a slow reactivity towards metallic sodium. A slow reactivity may generally be characterized as having a solvent reduction potential of less than 1.1 V vs Na/Na+, and more preferably of less than 0.9 V vs Na/Na+, and more preferably less than 0.7 V vs Na/Na+, and most preferably less than 0.5 V vs Na/Na+. Other ranges are possible according to the invention.

In one embodiment, such stable cycling can be achieved when the electrolyte salt contains sodium-trifluoromethanesulfonate (Na-Triflate), and the electrolyte contains an SO₂ additive. Without intending to be bound by theory, the stable cycling capability in this case is thought to result from the Solid Electrolyte Interface (SEI) layer being comprised of mainly Na₂S₂O₄, Na₂O, Na₂S, and/or NaF, originating from the SO₂ additive and Na-Triflate salt, without a significant contribution to the SEI by the solvent decomposition products. Thus, the SEI is believed to form synergistically with the SO₂ additive.

In an other embodiment, it is surprisingly found that such stable cycling can be achieved with any electrolyte salt that is not reduced by sodium, provided that it dissolves in the electrolyte to at least 1 molar concentration, and more preferably to at least 1.2 molar concentration, and more preferably to at least 1.5 molar concentration, and most preferably to at least 2 molar concentration, and that the electrolyte contains dissolved SO₂ in at least a 0.05 mole fraction, and more preferably in at least a 0.1 mole fraction, and most preferably contains dissolved SO₂ in at least 0.2 mole fraction. Other ranges are possible according to the invention. Without intending to be bound by theory, the stable cycling capability in this case is thought to result from the SEI layer being comprised of mainly Na₂S₂O₄, Na₂O and/or Na₂S, originating from the SO₂ component and without a significant contribution to the SEI from the solvent decomposition products. Thus, the SEI is again believed to form synergistically with the SO₂ additive.

Therefore, these discoveries enable the range of applicable solvents to be any non-aqueous solvent which has a slower reactivity towards metallic sodium than SO₂ and Na-Triflate in particular and to a wide range of electrolytic salts that are not reduced by sodium and yet dissolve in the solvent.

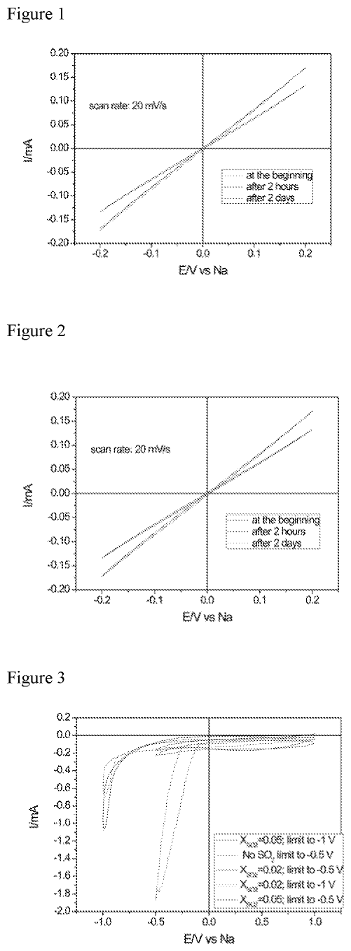

FIGS. 1 and 2 show the sodium deposition/stripping voltammograms for the abovesaid electrolyte compositions, with diglyme solvent and with DOL:DME solvent mixture respectively.

Beyond sodium-over-sodium cycling stability, it is desired for the electrolyte to also support metallic sodium deposition capability over a current collector substrate, in order to facilitate discharged state cell assembly. Considering the electrolytes investigated in [2], it is found that they do not support metallic sodium deposition over any substrate. As shown in FIG. 3, even the addition of up to 0.05 SO₂ additive mole fraction has not improved their deposition capability, as the anodic processes remained virtually absent.

Surprisingly, it has been discovered that the above-disclosed new classes of electrolytes facilitates a non-dendritic/dendrite-free deposition of metallic sodium when the anodic current collector is comprised of copper or some copper-based alloy.

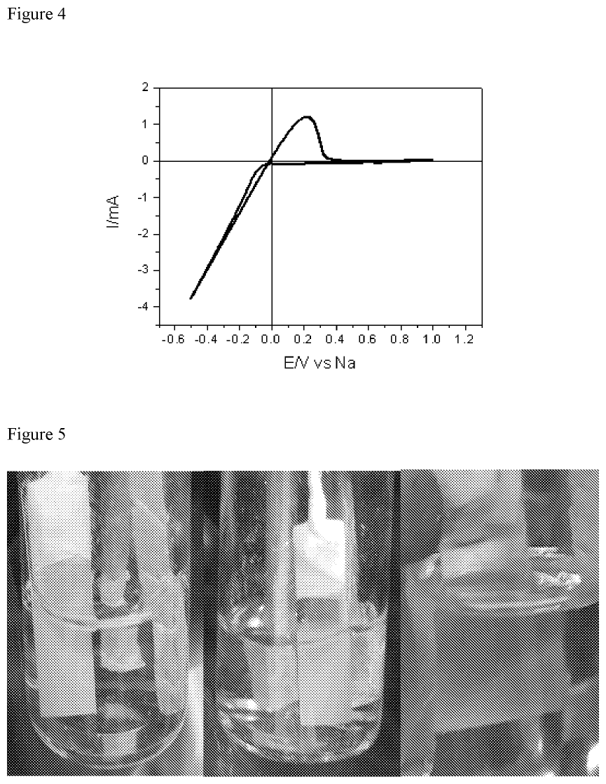

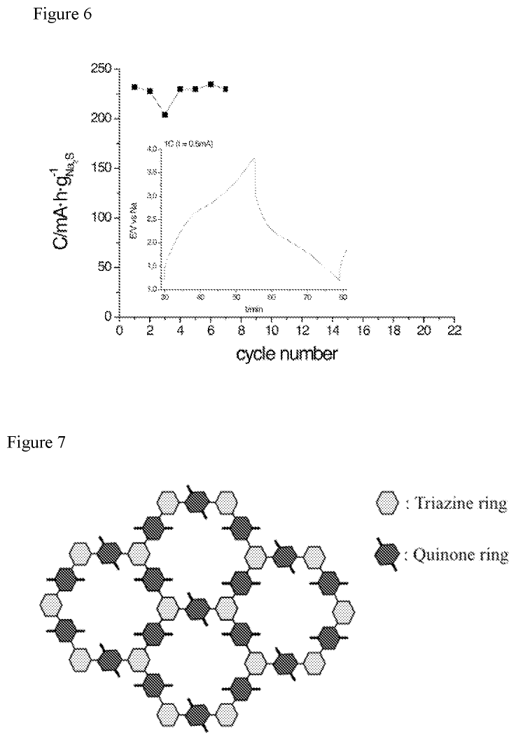

FIG. 4 shows the sodium deposition/stripping voltammograms over a copper current collector foil, with DOL:DME solvent based electrolyte.

The range of electrolyte compositions facilitating both sodium deposition and its stable cycling has been investigated. According to the invention, the electrolyte solvent may be selected from any solvent which has a slower reactivity towards metallic sodium than the SO₂ additive and a salt, preferably the Na-Triflate salt, though other salts are possible according to the invention. The range of feasible electrolyte solvents includes, but is not limited to, ether, amine, and oxadiazole type solvents. Examples of particularly useful solvents are disclosed further below.

When sodium deposition and stable cycling are achieved through the combined effects of the electrolyte salt and the SO₂ additive, the range of particularly effective salts includes fluorinated sulfonate and/or fluorinated carboxylate and/or fluorinated sulfonylimide and/or acetate type electrolyte salts. Fluorinated sulfonate and/or fluorinated carboxylate and/or fluorinated sulfonylimide and/or acetate type/based salts usable according to the invention include, but are not limited to, sodium-trifluoromethanesulfonate (Na-Triflate) and similar salts: including but not limited to sodium-pentaluoroethanesulfonate (Na—C₂F₅SO₃), sodium bis (trifluoromethanesulfonyl)imide (NaTFSI), sodium bis(flourosulfonyl)imide (NaFSI), and sodium-trifluoroacetate (Na—CF₃CO₂). In order to improve the electrolyte conductivity, these salts may be used in combination with other electrolyte salt types. The concentration of the Na-Triflate type electrolyte salt component is preferably between 0.5 molar and 3 molar, and more preferably between 1 molar and 2.5 molar. The mole fraction of the SO₂ additive may range between 0.001 and 0.2, and is preferably between 0.01 and 0.15, and more preferably between 0.05 and 0.1. Other ranges are possible according to the invention. FIG. 5 shows the comparative visual aspect of sodium deposition over a copper current collector foil, with different mole fraction values of the SO₂ additive.

In one of the embodiments, namely when sodium deposition and stable cycling are achieved through the effect of a significant mole fraction of dissolved SO₂, it has been found that the concentration of electrolyte salts is correlated with the smoothness of the deposited metallic sodium surface. The abovesaid minimum salt concentration is needed for creating a sufficient smoothness of the deposited metallic surface. The use of NaSCN salt is particularly preferred because of its high solubility in ether based solvents and its cost-effectiveness, though other salts are possible according to the invention. The concentration of the electrolyte salts is preferably between 1.2 molar and 10 molar, and more preferably between 1.3 and 5 molar and more preferably between 1.4 and 3 molar and most preferably between 1.5 molar and 2.5 molar. The mole fraction of the dissolved SO₂ may preferably range between 0.02 and 0.5, and more preferably between 0.02 and 0.3, and most preferably between 0.05 and 0.1. Other ranges are possible according to the invention.

Particularly preferred electrolyte formulations are disclosed in the following paragraphs. In one embodiment, namely for batteries having a moderate operating voltage range of up to approximately 3.5 V, the use of DOL:DME solvent, is preferred, with SO₂ additive employed preferably in the 0.001 to 10 mole fraction range and more preferably in the 0.01 to 0.2 mole fraction range, more preferably at 0.02 mole fraction. A corresponding preferred electrolyte salt is Na-Triflate:NaSCN, Na-Triflate:NaNO₃, Na-Triflate:NaTFSI, or Na-Triflate:NaPF₆ composition, where the Na-Triflate part ensures the anode stability while the optional NaSCN, NaNO_{3,}, NaTFSI, or NaPF₆ part may improve ionic conductivity. The employed Na-Triflate concentration is preferably in the 0.5 to 2 molar range, and the employed NaSCN, NaNO₃, NaTFSI, or NaPF₆ concentration is preferably in the 1 to 2 molar range, altogether resulting in 2 to 3 molar salt concentration. Other molar ranges are possible according to the invention, e.g. Na-Triflate molar concentration can range from 0.1 to 10, the NaSCN, NaTFSI, NaNO₃, or NaPF₆. molar concentration can range from 0.2 to 20 and the total molar salt concentration can range from 0.3 to 30. A particularly preferred composition is the employment of 1.5 M NaSCN+1 M Na-Triflate salt mixture. This electrolyte formulation is particularly effective in the case of Sulfur-based cathodes, because the SO₂ additive is thought to generate a thin layer of sodium-dithionite on the cathode surface, which is conductive for Na+ ions but mitigates the dissolution of polysulfide species. Other salt compositions are possible according to the invention.

In one embodiment, namely for batteries having a higher operating voltage range of up to approximately 4.5 V, the use of DX (1,4-dioxane):DME (1,2-dimethoxyethane) ether solvent mixtures is preferred, with SO₂ additive preferably employed 0.001 to 0.3 mole fraction range, and more preferably in the 0.02 to 0.2 mole fraction range, and more preferably at approximately 0.1 mole fraction. Other ranges are possible according to the invention. Any mixture of DX and DME solvents is possible according to the invention. The preferred volumetric DX:DME ratio is 1:2, in accordance with the melting point and viscosity optimization described in [7]. The employed Na-Triflate concentration is preferably in the 0.5 to 2.5 molar range. Pyridine may, in some cases, be preferred over or in combination with DX and/or DME because of its low cost, low viscosity, and very low reactivity towards sodium. In order to improve ionic conductivity with respect to using just Na-Triflate salt, a mixture of salts may be used; one preferred electrolyte salt composition being the Na-Triflate:NaPF₆ mixture, where the Na-Triflate part ensures the anode stability while the NaPF₆ part improves ionic conductivity. Other salt compositions are possible according to the invention.

In one embodiment, namely for batteries requiring a very high operating voltage range, possibly up to approximately 5.7 V, the use of furazan (1,2,5-Oxadiazole) type solvents is preferred, with SO₂ additive employed in the 0.001 to 0.3 mole fraction range, and preferably in the 0.01 to 0.04 mole fraction range, and more preferably at approximately 0.02 mole fraction. Other ranges are possible according to the invention. Furazan type solvents have been discovered to possess a surprisingly high oxidation potential level in the range of 6 V vs Na/Na+, along with a reasonably high boiling point, good solvent properties, and low reactivity towards metallic sodium. The group of furazan type solvents includes, but is not limited to, furazan, methyl-furazan, and dimethyl-furazan. Corresponding preferred electrolyte salts are pure Na-Triflate or Na-Triflate:NaBF₄ compositions, where the Na-Triflate part may promote the anode stability while the NaBF₄ part may optionally improve ionic conductivity. The employed Na-Triflate concentration is preferably in the 1 to 4 molar range and more preferably in the 1.2 to 2 molar range, when used without any additional salt. Other ranges are possible according to the invention. In case of employing Na-Triflate:NaBF₄ composition, the Na-Triflate concentration is preferably in the 0.5 to 4 molar range and more preferably in the 1 to 2 molar range, and the employed NaBF₄ concentration is preferably also 0.5 to 4 molar range and more preferably in the 1 to 2 molar range, altogether resulting in 1.5 to 8 and more preferably in the 2 to 4 molar salt concentration. Besides NaBF₄ and Na-Triflate, other possible high voltage possibilities salts include NaPF₆, NaClO₄, NaB(CN)₄, NaBF₃CN, NaBF₂(CN)₂, NaBF(CN)₃, NaAl(BH₄)₄. Other salt compositions are possible according to the invention. Other ranges are possible according to the invention.

The following paragraphs describe high-capacity and cost-effective cathode materials, which are compatible with the abovesaid new electrolytes formulations, and facilitate discharged state preparation of the sodium based cell.

It has been surprisingly discovered that partially oxidized Na₂S material can be activated. Electrodes constructed from oxidized Na₂S particles, and with an in-situ deposited polypyrrole conductive additive have been prepared. The in-situ polypyrrole deposition has been achieved by dispersing the abovesaid Na₂S particles in anhydrous methyl-acetate containing FeCl₃ as an oxidant and poly(vinyl acetate) as a stabilizing agent, followed by the addition of pyrrole. The polypyrrole deposition has taken place at room temperature after 12 hours reaction time. A stable capacity of approximately 220 mAh/g has been obtained with respect to the Na₂S mass in DME solvent based electrolyte. A practical means of carrying out partial Na₂S oxidation is to heat it under vacuum preferably in the 125-300° C. range, and more preferably in the 150-250° C. range, most preferably at approximately 200° C. for some hours. The residual Oxygen content of vacuum will gradually oxidize the Na₂S at that temperature. In one embodiment, this heat treatment may range between 0.5 and 10 hours, more preferably between 1 and 5 hours and more preferably between 1.5 and 3 hours and most preferably about 2 hours. Other process temperatures and process times are possible according to the invention. Other means of carrying out partial Na₂S oxidation is possible according to the invention. The production of cost-effective Sodium-Sulfur batteries therefore becomes feasible, according to the process disclosed herein.

As a well-matching cathode for the above-disclosed high voltage electrolytes, Na₂MgO₂ has been discovered to be chargeable to Magnesium-peroxide (MgO₂) during the battery charging, surprisingly giving rise to a stable charge/discharge capacity and a charge/discharge voltage in the range of 4.6 V. According to the invention, an electrochemical cell, wherein the active cathode material material comprises Na₂MgO₂ ternary oxide materials, may also include its variations where the Na, Mg, and O constituents may be partially replaced by other elements.

Surprisingly, it has been discovered that NaBr salt or NaBr:NaCl salt mixture may be employed as an energy-dense cathode material with the abovesaid electrolytes, particularly in the case of using an electrolyte with at least 3.9 V voltage window. In a preferred embodiment, a carbon framework, preferably Ketjen-Black type carbon, is infused by the NaBr salt, whereby this type carbon is used as a conductive framework material. Upon cell charging, NaBr is oxidized into NaBr₃ salt. For best reversibility, further full oxidation into Br₂ catholyte is preferred to be avoided, and furthermore a cation-conducting film, such as a Nafion-coated separator [8], is preferred to be used to mitigate a cross-over of dissolved Brₐ⁻ anions. Without intending to be bound by theory, it is believed that on the anode side the operation of this simple Na—Br cell is made possible by the electrically insulating qualities of the formed SEI and the anion/Br₂ cross-over hindering capability of the employed cation-conducting film. On the cathode side, it is believed that the operation of the Na—Br cell is made possible by the NaBr salt crystallization away from the carbon surface, thereby preventing the passivation of the electrode surface upon discharge. Despite not being in direct electric contact with the carbon surface, the NaBr is electrochemically active; a small amount of dissolved NaBr or NaBr₃ is oxidized to Br₂, which initiates NaBr to NaBr₃ conversion of the NaBr active. Ether type solvents have a limited direct solubility of NaBr and NaBr₃ salts. Therefore the theoretical energy density of the 3 NaBr↔2 Na+NaBr₃ reaction can be realized to nearly its full extent. Furthermore, NaBr may be partially replaced by NaCl for improving the energy density of the cathode; up to 1:2 NaCl:NaBr molar ratio may be used without gas evolution upon charging. The 1:2 NaCl:NaBr ratio results in the formation of NaBr₂Cl oxidized salt. The NaBr and NaCl:NaBr cathode material may be used with electrolyte formulations supporting a voltage window of at least 3.9 V charging voltage. DX:DME mixture is a preferred solvent, because of its good Na anode compatibility, its high oxidation voltage (around 4.5 V vs Na/Na+), and its reasonably high ionic conductivity. Other solvents, and in particular solvents with low reactivity with respect to metallic sodium, high oxidation voltage, preferably above 4 and more preferably above 4.5 and most preferably above 4.6 V vs Na/Na+, and concentrations of solute NaBr is above 0.005 Molar and more preferably above 0.05 Molar and most preferably above 0.5 Molar are possible according to the invention.

According to the invention, an electrochemical cell, wherein the active cathode material material comprises NaBr, may include its variations where the Na, Br, and Cl constituents may be partially replaced by other elements.

According to the invention, in references to carbon and carbon frameworks, the carbon may be in any suitable form. Preferred forms of carbon include CNT, fullerene, CNB, graphene, graphite, Ketjen-Black, mesoporous carbon, activated carbon, Y-carbon, nanocarbon, carbon nanoparticle and/or porous carbon. Other forms of carbon are possible according to the invention.

A new polymer type high-energy cathode material has been furthermore discovered, which complements well the above disclosed electrolyte formulations. This cathode material is a co-polymer of triazine rings and quinone rings. Its structure is shown in FIG. 7. This material may be described by the [C₈H₂N₂O₂Na₂]ₙ formula, and self-arranges during its synthesis into a micro-porous structure, where well-defined 1-2 nm wide channels facilitate the ion migration. This material can be reversibly cycled down to the 1.3 V vs Na/Na⁺ low voltage limit. Both the triazine and quinone rings contribute to its cycling capacity, resulting in a very high specific capacity, measured to be in excess of 300 mAh/g.

An exemplary procedure for the abovesaid Triazine-Quinone co-polymer synthesis may be based on the 2,5-dichloro-1,4-hydroquinone starting material. This precursor is firstly stirred in aqueous or alcohol-based NaOH solution for achieving H⁺ to Na⁺ ion exchange. After subsequent evaporation of the solvent, it is stirred in hot DMSO based solution of NaCN for achieving

Chloride to Cyanide ligand exchange. A suitable temperature range for this reaction is between 100 and 150° C. Subsequently, it is mixed with NaOH—NaCl salt eutectic, and subjected to ionothermal heat treatment in the 300 to 400° C. temperature range. The micro-porous polymer structure is self-assembled during this heat treatment. The final polymer is then obtained after washing away the salts and filtration.

According to the invention, the terms “x-cored”, “x-type” and “x-based” with regards to materials or material class x refers to materials having x as an essential or identifiable component of the material. The term “similar as”, according to the invention means materials having properties or characteristics relevant to the invention which are similar to the referred to material(s) and which can be readily substituted for the specific material(s) referenced.

One embodiment of the invention comprises an electrochemical cell, comprising a cathode and an anode and a non-aqueous electrolyte which comprises an SO₂ additive and at least one electrolyte salt which participates in the anodic SEI formation together with the SO₂ additive positioned between the cathode and anode.

One embodiment of the invention comprises an electrochemical cell, comprising a cathode and an anode and an electrolyte which comprises a sufficient amount of dissolved SO₂ for a stable SEI formation at least one electrolyte salt which is soluble to at least 1.2 molar concentration positioned between the cathode and anode.

In one embodiment of the invention, the salt participating in the SEI formation comprises fluorinated sulfonate and/or fluorinated carboxylate and/or fluorinated sulfonylimide and/or acetate salt.

In one embodiment, the salt participating in the SEI formation is selected from sodium trifluoromethanesulfonate (NaTriflate), sodium-pentaluoroethanesulfonate (Na—C₂F₅SO₃) and sodium-trifluoroacetate (Na—CF₃CO₂) or other similar salts.

In one embodiment, the non-aqueous electrolyte solvent comprises one or more ether, amine, or oxadiazole type solvents, or any mixture thereof.

In one embodiment, the solvent is preferably selected from 1,3-Dioxolane, 1,2-Dimethoxyethane, 1,4-Dioxane, diglyme, glyme, pyridine, furazan, methyl-furazan, dimethyl-furazan or any mixture thereof.

In one embodiment, the electrolyte salt at least partially comprises NaBF₄, NaSCN, NaPF₆, NaClO₄, NaB(CN)₄, NaBF₃CN, NaBF₂(CN)₂, NaBF(CN)₃, or NaAl(BH₄)₄.

In one embodiment, the anodic current collector substrate is selected from copper or its alloys.

One embodiment of the invention comprises an electrochemical cell for a battery, wherein the active cathode material material comprises partially oxidized Na₂S.

One embodiment of the invention comprises an electrochemical cell, wherein the active cathode material material comprises Na₂MgO₂ ternary oxide material, including its variations where the Na, Mg, and constituents may be partially replaced by other elements.

One embodiment of the invention comprises an electrochemical cell, wherein the active cathode material material comprises NaBr or NaBr:NaCl salt mixture, including its variations where the Na, Br, and Cl constituents may be partially replaced by other elements.

One embodiment of the invention comprises an electrochemical cell, wherein the active cathode material material comprises Triazine-Quinone co-polymer.

One embodiment of the invention comprises an electrochemical cell employing any of the electrolytes, anode structure and/or the cathodes of any embodiment of the invention.

One embodiment of the invention comprises a method of manufacturing an electrochemical cell, comprising providing a cathode and an anode and providing a non-aqueous electrolyte which comprises an SO₂ additive and at least one electrolyte salt which participates in the anodic SEI formation together with the SO₂ additive.

One embodiment of the invention comprises a method of manufacturing an electrochemical cell, comprising providing a cathode and an anode and providing an electrolyte which comprises a sufficient amount of dissolved SO₂ for a stable SEI formation at least one electrolyte salt which is soluble to at least 1.2 molar concentration.

One embodiment of the invention comprises the method of any embodiment of the invention wherein the salt participating in the SEI formation comprises fluorinated sulfonate and/or fluorinated carboxylate and/or fluorinated sulfonylimide and/or acetate salt.

In one embodiment of the invention, the salt participating in the SEI formation is selected from sodium trifluoromethanesulfonate (NaTriflate), sodium- pentaluoroethanesulfonate (Na—C₂F₅SO₃) and sodium-trifluoroacetate (Na—CF₃CO₂) or other similar salts.

In one embodiment, the non-aqueous electrolyte solvent comprises one or more ether, amine, or oxadiazole type solvents, or any mixture thereof.

In one embodiment, the electrolyte salt at least partially comprises NaBF₄, NaSCN, NaPF₆, NaClO₄, NaB(CN)₄, NaBF₃CN, NaBF₂(CN)₂, NaBF(CN)₃ or NaAl(BH4)4.

One embodiment of the invention comprises a rechargeable battery comprising of a single or plurality of electrochemical cells as described in any embodiment of the invention or made by any of the methods of any embodiment of the invention.

One embodiment of the invention comprises an electric vehicle, an electrical or electronic device, a power unit, a backup energy unity or a grid storage or stabilization unit utilizing an electrochemical cell, battery or supercapacitor according to any embodiment of the invention or an electrochemical cell, battery or supercapacitor made according to the method of any embodiment of the invention.

Consequently, a skilled person may on the basis of this disclosure and general knowledge apply the provided teachings in order to implement the scope of the present invention as defined by the appended claims in each particular use case with necessary modifications, deletions, and additions. The fulcrum will substantially remain the same.

### EXAMPLES

### Preparation of Electrolytes

### Example 1

The DOL:DME electrolyte has been prepared from different volumetrics mixtures of DOL and DME by cooling down to −20° C. and, a suitable volume of condensed SO₂ was added in order to reach 0.02 SO₂ mole fraction. After letting the mixture to warm up to room temperature, 1 M Na-Triflate and 1.5 M NaSCN salts have been dissolved into it.

### Example 2

Furazan has been cooled to −20° C., then a suitable volume of condensed SO₂ has been added into it, in order to reach 0.02 SO₂ mole fraction. After letting the mixture to warm up to room temperature, 2 M Na-Triflate salt has been dissolved into it.

### Example 3

DME has been cooled to −20° C. A suitable volume of condensed SO₂ has been added into it, in order to reach 0.02 SO₂ mole fraction. After letting the DME to warm up to room temperature, the DX:DME based solvent has been prepared by adding DX solvent to reach 1:2 volumetric mixture of DX and DME. 2 M Na-Triflate salt has been dissolved into this mixture.

### Preparation of the Active Material

### Example 4

Na₂S-PPY was obtained by firstly removing the hydration water from Na₂S·9H₂O through drying in several steps: first, the Na₂S·9H₂O was heated at 50° C. for 240 minutes, then the temperature was increased to 80° C. for 240 minutes. In the third step, the temperature was 120° C. during 2 hours. In the last step, the temperature was increased to 200° C. for 2 hours to obtain the partially oxidized dry Na₂S. Finally, polypyrrole was polymerized onto Na₂S according to the procedure described in [5], yielding the Na₂S-PPY material.

### Preparation of the Positive Electrode

### Example

5

80 wt % of Na₂S-PPY from Example 4, 15 wt % of carbon nanotubes and 5 wt % of PVDF (polyvinilidenefluoride) were dispersed in N-methylpyrrolidone under magnetic stirring at room temperature to form a slurry. Then the slurry was coated onto carbon-coated aluminum foil. Finally, the electrode was dried at 80° C. under vacuum overnight.

### Example 6

The electrode framework was prepared from a mixture of 94 wt % Ketjen-Black carbon and 6 wt % of PTFE. This mixture was dry-pressed onto carbon-coated aluminum current collector, according to the dry-pressing procedure of [6]. NaBr was dissolved in anhydrous methanol, and the solution was drop-cast onto the electrode in sufficient amount to obtain approximately 3.7:1 mass ratio between the NaBr and carbon. Finally, the electrode was dried at 80° C. overnight in vacuum.

### Example 7

The electrode framework was prepared from a mixture of 94 wt % Ketjen-Black carbon and 6 wt % of PTFE. This mixture was dry-pressed onto carbon-coated aluminum current collector, according to the dry-pressing procedure of [6]. 1:2 molar ratio of NaCl:NaBr was dissolved in anhydrous methanol, and the solution was drop-cast onto the electrode in sufficient amount to obtain approximately 4:1 mass ratio between these salts and carbon. Finally, the electrode was dried at 80° C. overnight in vacuum.

### Preparation of the rechargeable batteries

### Example 8

A rechargeable sodium battery was prepared having a copper foil negative electrode, a porous polyethylene separator of 15 micron of thickness, and the Na₂S-PPY based positive electrode from Example 5. The cell was filled with the electrolyte from example 1. The battery prepared for this example exhibited a capacity of 220 mAh/g respect to the Na₂S mass.

### Example 9

A rechargeable sodium battery was prepared having a copper foil negative electrode, a Nafion-coated porous polyethylene separator of 15 micron of thickness, which has been prepared according to [8], and the NaBr based positive electrode from Example 6. The cell was filled with the electrolyte from example 3. The battery prepared for this example exhibited a rechargeable capacity of 160 mAh/g respect to the NaBr mass.

### Example 10

A rechargeable sodium battery was prepared having a copper foil negative electrode, a Nafion-coated porous polyethylene separator of 15 micron of thickness, which has been prepared according to [8], and the NaBr:NaCl based positive electrode from Example 7. The cell was filled with the electrolyte from example 3. The battery prepared for this example exhibited a rechargeable capacity of 185 mAh/g respect to the NaBr:NaCl mass.

### REFERENCES

1. Patent application FI 20150270.
2. Seh et al. ACS Cent. Sci. (2015); 1: 449-455
3. Kobayashi et al. Journal or Power Sources (2016); 306: 567-572
4. Seh et al. Nature Comm. (2014); 5: 5017.
5. Seh et al. Energy Environ. Sci. (2014); 10: 1039.
6. Patent number DE 10 2012 203 019 A1
7. Miao et al. Nature Scientific Reports (2016); 6: 21771
8. Bauer et al. Chem. Commun. (2014); 50:3208-3210.

1. An electrochemical cell, comprising:
a) a cathode and a rechargeable metallic sodium anode; and
b) a non-aqueous electrolyte which comprises an SO₂ additive and at least one electrolyte salt which participates in the anodic SEI formation together with the SO₂ additive positioned between the cathode and the anode.

2. An electrochemical cell, comprising:
a cathode and a rechargeable metallic sodium anode; and
an electrolyte which comprises a sufficient amount of dissolved SO₂ for a stable SEI formation and at least one electrolyte salt which is soluble to at least 1.2 molar concentration positioned between the cathode and anode.

3. The cell of claim 1, wherein the salt participating in the SEI formation comprises fluorinated sulfonate and/or fluorinated carboxylate salt and/or fluorinated sulfunylimide and/or acetate salt.

4. The cell of claim 3, wherein the salt participating in the SEI formation is selected from sodium trifluoromethanesulfonate (NaTriflate), sodium-pentaluoroethanesulfonate (Na-C₂F₅SO₃), sodium bis (trifluoromethanesulfonyl)imide (NaTFSI), sodium bis(flourosulfonyl)imide (NaFSI), and sodium-trifluoroacetate (Na-CF₃CO₂) or other similar salts.

5. The cell of claim 1, wherein the non-aqueous electrolyte solvent comprises one or more ether, amine, or oxadiazole type solvents, or any mixture thereof.

6. The cell of claim 5, wherein the solvent is preferably selected from 1,3-Dioxolane, 1,4-Dioxane, 1,2-Dimethoxyethane, diglyme, glyme, pyridine, furazan, methyl-furazan, dimethyl-furazan or any mixture thereof.

7. The cell of claim 1, wherein the electrolyte salt at least partially comprises NaBF₄, NaSCN, NaPF₆, NaClO₄, NaB(CN)₄, NaBF₃CN, NaBF₂(CN)₂, NaBF(CN)₃, or NaAl(BH₄)₄.

8. The cell of claim 1, wherein the anodic current collector substrate is selected from copper or its alloys.

9. An electrochemical cell, wherein the active cathode material comprises partially oxidized Na₂S.

10-12. (canceled)

13. The electrochemical cell employing the electrolyte of claim 1, the anode structure of claim 8, and/or the cathode of any of claim 9.

14. A method of manufacturing an electrochemical cell, comprising:
a) providing a cathode and a rechargeable metallic sodium anode; and
b) providing a non-aqueous electrolyte which comprises an SO₂ additive and at least one electrolyte salt which participates in the anodic SEI formation together with the SO₂ additive.

15. A method of manufacturing an electrochemical cell, comprising:
a) providing a cathode and a rechargeable metallic sodium anode; and
b) providing an electrolyte which comprises a sufficient amount of dissolved SO₂ for a stable SEI formation and at least one electrolyte salt which is soluble to at least 1.2 molar concentration.

16. The method of claim 14, wherein the salt participating in the SEI formation comprises fluorinated sulfonate and/or fluorinated carboxylate salt and/or fluorinated sulfonylimide and/or acetate salt.

17. The method of claim 14, wherein the salt participating in the SEI formation is selected from sodium trifluoromethanesulfonate (NaTriflate), sodium-pentaluoroethanesulfonate (Na-C₂F₅SO₃) and sodium-trifluoroacetate (Na-CF₃CO₂), sodium bis (trifluoromethanesulfonyl)imide (NaTFSI), sodium bis(flourosulfonyl)imide (NaFSI), or other similar salts.

18. The method of claim 14, wherein the non-aqueous electrolyte solvent comprises one or more ether, amine, or oxadiazole type solvents, or any mixture thereof

19. The method of claim 18, wherein the solvent is preferably selected from 1,3-Dioxolane, 1,4-Dioxane, 1,2-Dimethoxyethane, diglyme, glyme, pyridine, furazan, methyl-furazan, dimethyl-furazan or any mixture thereof.

20. The method of claim 14, wherein the electrolyte salt at least partially comprises NaBF₄, NaSCN, NaPF₆, NaCO₄, NaB(CN)₄, NaBF₃CN, NaBF₂(CN)₂, NaBF(CN)₃, or NaAl(BH₄)₄.

21. The method of claim 14, wherein the anodic current collector substrate is selected from copper or its alloys.

22. A rechargeable battery comprising of a single or plurality of electrochemical cells as described in claim 1, or made by the method of claim 14.

23. An electric vehicle, an electrical or electronic device, a power unit, a backup energy unity or a grid storage or stabilization unit utilizing:
a) an electrochemical cell, battery or supercapacitor according claim 1; or
b) an electrochemical cell, battery or supercapacitor made according to the method of claim 14.
